(19) United States
(12) Patent Application Publication
(10) Pub. No.: US 2026/0142215 A1
(43) Pub. Date: May 21, 2026

(54) Apparatus, System and Method for Continuous Battery Stacking with Singulation Drum

(71) Applicant: DW Energy LLC, Wilsonville, OR (US)

(72) Inventors: Derek Aqui, Portland, OR (US); Brady Byers, Newberg, OR (US)

(21) Appl. No.: 19/385,669

(22) Filed: Nov. 11, 2025

Related U.S. Application Data
(60) Provisional application No. 63/720,860, filed on Nov. 15, 2024.

(51) Int. Cl. H01M 10/04

(52) U.S. Cl. CPC H01M 10/0404; H01M 10/0459

(57) ABSTRACT

The present invention relates to an apparatus, method and system for continuously picking singulated electrodes and separators from an indexing singulation drum and placing each onto a downstream process as part of a battery stacking system that utilizes a self-correcting stacking platform. The rotating singulation drum includes a deformable shoe mechanism for handling battery material during high-precision stacking processes. The deformable shoe, integrated into the rotating singulation drum, adjusts dynamically to the shape of the infeed and downstream processes, allowing for smooth, continuous contact during pick-and-place operations. This flexibility ensures consistent distribution and minimizes the risk of misalignment or damage during transfer. This innovation optimizes high-speed stacking, contributing to improved battery manufacturing efficiency and reliability.

### CROSS-REFERENCE TO OTHER APPLICATION

This Application claims the benefit of and priority to U.S. Provisional Application No. 63/720,860 filed November 15, 2024, the contents of which are hereby incorporated by reference.

### COPYRIGHT NOTIFICATION

Portions of this patent application contain materials that are subject to copyright protection. The copyright owner has no objection to the facsimile reproduction by anyone of the patent document or the patent disclosure, as it appears in the U.S. Patent and Trademark Office, but otherwise reserves all copyright rights whatsoever.

### BACKGROUND OF THE DISCLOSURE

Battery stacking, a critical process in modern battery manufacturing, involves arranging multiple battery cells to form a complete module or pack. The cells, which can be cylindrical, prismatic, or pouch-shaped, are stacked in layers with alternating anode and cathode layers, separated by insulating separators.

The battery stacking process aims to increase the energy density and power capacity of battery systems, making it a key technology in applications such as electric vehicles (EVs), grid storage, and portable electronics. In order to achieve such objectives, the stacking process must ensure consistent alignment and minimal spacing to avoid performance losses or safety risks due to short circuits or thermal events.

During the battery stacking process, automated systems are often used to handle the precise placement of electrodes and separators. The critical challenge in battery stacking manufacturing is maintaining high throughput while ensuring the accurate alignment of each layer. Such challenges are particularly important in high-performance batteries, such as those using lithium-ion chemistry, where even slight misalignments can affect the electrochemical performance and lifecycle of the battery. Innovations in automation and robotics, such as laser alignment and machine vision systems, are increasingly employed to improve the precision and speed of the stacking process. This not only enhances production efficiency but also significantly reduces the cost of high-volume battery manufacturing, painting an optimistic picture of the future of the industry.

Another essential consideration in battery stacking manufacturing is the need for effective quality control. As batteries become more energy-dense and are used in safety-critical applications, such as EVs, the quality and consistency of the stacking process must be monitored in real time. Techniques like X-ray inspection and impedance spectroscopy detect defects, such as misaligned cells or foreign particles, that may lead to performance degradation or safety issues. As the demand for higher-capacity batteries continues to grow, further advancements in automation, materials handling, and defect detection technologies will be crucial for scaling up battery stacking manufacturing while maintaining stringent safety and performance standards.

Z-stacking, also known as Z-folding, batteries, while offering higher energy density by vertically stacking cells in layers, has several limitations and challenges. One of the primary issues is the difficulty in ensuring precise alignment across multiple layers, as any misalignment can result in uneven pressure distribution, leading to mechanical stress on the electrodes and separators. This can cause performance degradation, internal short circuits, or even thermal runaway in extreme cases. Because Z-stacking requires continuously offsetting the separator web from side-to-side during lamination to fold over to the next layer, visually inspecting the stack for accuracy and minimizing excess electrode and separator material to prevent the mechanical issues described above are difficult and expensive to implement, leading to higher manufacturing costs due to large amounts of wasted material per stack manufactured.

Another challenge is heat dissipation; with cells stacked closely together, heat can accumulate within the pack, increasing the risk of overheating and reducing the battery’s lifespan. Additionally, the complexity of automated stacking processes, particularly for thin and flexible components like separators in lithium-ion batteries, can lead to manufacturing defects if not carefully controlled. These limitations highlight the need for advanced manufacturing techniques and rigorous quality control measures to ensure the safety and reliability of Z-stacked batteries in high-demand applications like electric vehicles and energy storage systems.

Therefore, what is missing in battery stacking systems today is a continuous singulated battery stacking system and method that contains more advanced alignment technologies and real-time quality control methods that can ensure greater precision and reduce manufacturing defects at scale than traditional Z-stacking systems.

### BRIEF SUMMARY OF THE DISCLOSURE

This summary is provided to introduce a selection of concepts in a simplified form that are further described in the detailed description of the disclosure. This summary is not intended to identify key or essential inventive concepts of the claimed subject matter, nor is it intended to determine the scope of the claimed subject matter.

The present invention generally relates to a system for continuously picking singulated electrodes and separators and placing each onto a downstream battery stacking process. In an embodiment, the continuously stacking system includes a first rotating singulation drum, wherein the first rotating singulation drum is configured to singulate and transfer anode sheets from a first upstream process; a second rotating singulation drum, wherein the second rotating singulation drum is configured to singulate and transfer cathode sheets from a second upstream process; a third rotating singulation drum, wherein the third rotating singulation drum is configured to singulate and transfer separator sheets from a third upstream process; a fourth rotating singulation drum, wherein the fourth rotating singulation drum is configured to singulate and transfer separator sheets from a fourth upstream process; wherein the first, second, third, and fourth rotating singulation drums include at least one deformable vacuum-assisted face, wherein the rotating singulation drum is configured to transfer an anode, a cathode, and a separator from the respective rotating singulation drums to a rotating picking prism using the at least one deformable vacuum-assisted gripping face; wherein the rotating picking prism is further configured to pick the anode, the cathode, and the separator from the at least one vacuum-assisted gripping face of the rotating singulation drum using one of at least three gripping shoes coupled to the rotating picking prism.

In an embodiment, the battery stacking system includes quality inspection devices that are adapted to inspect the cathodes, separators, and anodes before they are transferred to the rotating singulation drums.

In an embodiment, the battery stacking system includes quality inspection devices that are adapted to inspect the cathodes, separators, and anodes before they are transferred to the rotating picking prism.

In an embodiment, the battery stacking system includes an alignment device on each of the rotating singulation drums, which is configured to align the electrodes and separators while they are on the drums.

In an embodiment, the battery stacking system includes an alignment device on each of the rotating singulation drums, which is configured to align the electrodes and separators while they are continuously in motion and being transferred to the rotating picking prism.

The present disclosure relates to a battery manufacturing device capable of creating a battery stack using a continuous singulated lamination process by successively controlling a plurality of parameters, including the above-mentioned novel features, such as (but not limited to), in various embodiments, the alignment of anode and cathode sheets, the output speed of in-feed conveyors, and the pressure applied to battery material. The battery manufacturing device includes various sensors, including but not limited to pressure sensors, alignment sensors, tension sensors, temperature sensors, vibrational sensors, and cameras to ensure precise stacking and quality control.

### BRIEF DESCRIPTION OF THE DRAWINGS

The foregoing summary, as well as the following detailed description of the disclosure, is better understood when read in conjunction with the appended drawings. For the purpose of illustrating the disclosure, exemplary constructions of the inventions of the disclosure are shown in the drawings. However, the disclosure and the inventions herein are not limited to the specific methods and instrumentalities disclosed herein.

FIG. 1 shows a system for transferring battery material in accordance with an aspect of the present disclosure.

FIGS. 2A-2C show different stages of an operation for releasing a battery stack material in accordance with an aspect of the present disclosure.

FIGS. 3A-3C illustrate the rotating picking device or prism of FIGS. 2A-2C in accordance with an aspect of the present disclosure.

FIGS. 4A-4D show a rotating body of the singulation device and its vacuum regulation system in accordance with an aspect of the present disclosure.

FIGS. 5A-5C illustrate a rotating singulation body of FIG. 1 in accordance with an aspect of the present disclosure.

FIG. 6 shows a system including the singulation infeed region of the system of FIG. 1 in accordance with an aspect of the present disclosure.

FIGS. 7A-7B illustrate a battery stacking station in accordance with an aspect of the present disclosure.

### DETAILED DESCRIPTION OF THE DISCLOSURE

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

In the following detailed description, reference is made to the accompanying drawings that show, by way of illustration, a possible industrial embodiment of the disclosure centered around an improved battery stacking system. This embodiment is described with detail sufficient to enable one of ordinary skill in the art to practice the disclosure. It is understood that each subfeature or element described in this embodiment of the disclosure, although unique, is not necessarily exclusive and can be combined differently and in a plurality of other possible embodiments because they show novel features.

It is understood that the location and arrangement of individual elements, such as geometrical parameters within each disclosed embodiment, may be modified without departing from the spirit and scope of the disclosure. The disclosed apparatus can be modified according to known design parameters to implement this disclosure within these specific types of operation. Other variations will also be recognized by one of ordinary skill in the art. Therefore, the following detailed description is not to be taken in a limiting sense.

### System for transferring electrodes to a battery stack

The present disclosure relates to a system for continuously picking singulated electrodes and separators from an indexing singulation drum and placing each onto a downstream process as part of a battery stacking system that utilizes a self-correcting stacking platform. As discussed in the background section above, existing approaches to stacking electrodes and separator material have specific challenges. For example, conventional battery stacking systems have difficulty ensuring precise alignment across multiple layers, resulting in uneven pressure distribution, mechanical stress on electrodes and separators, performance degradation, internal short circuits, and thermal runaway.

Further, currently available conventional and existing approaches also have difficulty inspecting the electrodes and stack for placement accuracy due to manufacturing constraints related to using a continuous separator web. If the alignment of the layers is not correct, the stack will have to be trimmed, or the overall battery capacity will be reduced, which leads to higher manufacturing costs and wasted material. The stacking system 100 solves these issues by allowing for the continuous stacking of singulated electrodes and separator material while maintaining accuracy and manufacturing speeds that are not possible with existing methods.

As further disclosed herein, anodes and cathodes are referred to collectively as electrodes. A collection of alternating anodes and cathodes with a separator between adjacent anodes and cathodes is called a battery stack. Anodes, cathodes, and separators are referred to collectively as battery material.

In an aspect of the present disclosure, the stacking system 100 comprises a first infeed region comprising a first electrode dispensing device 110, a first electrode accumulation and a steering device 130. The stacking system 100 also includes a first indexing electrode singulation drum 150. By way of example and not limitation, in an embodiment, the first infeed region is configured to feed singulated cathodes to the rotating picking device or prism 170. The stacking system 100 also comprises a second infeed region that includes a second electrode dispensing device 110, a second electrode accumulation and steering device 130, and a second indexing electrode singulation drum 150. In an embodiment, the second infeed region is configured to feed singulated anodes to the rotating picking device or prism 170.

The stacking system 100 also comprises a third infeed region that includes a first separator dispensing device 120, a first separator accumulation and steering device 140, and a first indexing separator singulation drum 160. In an embodiment, the third infeed region is configured to feed singulated separators to the rotating picking device or prism 170. The stacking system 100 also comprises a fourth infeed region that includes a second separator dispensing device 120, a second separator accumulation and steering device 140, and a second indexing separator singulation drum 160. In an embodiment, the fourth infeed region is configured to feed singulated separators to the rotating picking device or prism 170.

The rotating picking device 170 is adapted to pick up singulated battery material from the first, second, third, and fourth infeed regions and then deposit the battery material at a battery stack 180, positioned at a battery stacking station 185. The infeed regions are designed to transport singulated anode, cathode, and separator sheets to the rotating picking device 170 with high precision and synchronization. These infeed regions contain one or more lanes or belts dedicated to different materials (anode, cathode, separator) to ensure seamless feeding into the stacking process. Equipped with features like vacuum-assisted gripping mechanisms, accumulation devices, sensors, and alignment devices, these infeed regions ensure that each singulated battery material is correctly positioned and aligned before entering the stacking system 100.

Advanced systems often integrate tension controls, speed adjustments, and robotic arms to handle delicate and thin materials, mainly separators, which are prone to deformation. Additionally, real-time quality checks such as optical or X-ray inspection systems can be incorporated along the conveyors to detect defects in materials before they reach the stacker, ensuring consistent quality and minimizing the risk of downstream issues.

The advantages of infeed regions are that they remove the need for cassettes and the system architecture associated with their loading, unloading, and conveying. When the need for cassettes is removed, the machine footprint shrinks considerably, and a high-speed stacker can run for longer durations.

The indexing electrode singulation drums 150 and indexing separator singulation drums 160 are configured to receive a continuous web of battery material and singulate the battery material while depositing the singulated battery material to the rotating picking device 170 with an indexing motion. The indexing electrode singulation drums 150 and indexing separator singulation drums 160 employ suction to adhere the battery material to the rotating drums. The indexing electrode singulation drums 150 and indexing separator singulation drums 160 are also configured to use a stream of air to push the battery material away from the rotating drums when releasing the battery material to the rotating picking device 170. In an embodiment, the switching between generating a vacuum or a jet of air is achieved using plumbed-in baffles within the indexing electrode singulation drums 150 and indexing separator singulation drums 160.

The accumulation and steering devices 130 and accumulation and steering devices 140 are configured to transition the continuous web of battery material from a continuous speed infeed motion to the indexing motion of the indexing electrode singulation drums 150 and indexing separator singulation drums 160.

In some embodiments, accumulation and steering devices 130 and accumulation and steering devices 140 include an alignment device configured to align the continuous web of battery material. It is beneficial to have the battery material positioned at the same, or substantially the same, position to minimize the amount of waste material and maximize the stacked battery capacity.

In some embodiments, the rotating picking device 170 includes multiple faces or shoes and is configured to rotate eccentrically in order to first pick up an electrode before depositing the electrode at the battery stacking station 185.

The use of an eccentrically rotatable multi-sided picking device 170 having at least three faces or shoes with arcuate gripper surfaces allows for continuous rotary motion based on a Reuleaux triangle. By way of example and not limitation, having the rotating picking device 170 rotating according to a Reuleaux triangle, constant width rotation within a square space is possible while simultaneously touching all four sides. However, a few challenges may arise with a pure Reuleaux triangle design: the complex non-circular orbital motion at the triangle’s center and the “scrubbing” effect caused by relative motion between the curved surface and electrodes during pick-and-place operations. These issues can be addressed through motion control or cam design, but a more straightforward rotary motion may be beneficial. To solve these problems, a modified Reuleaux triangle is proposed, featuring a non-slip profile path for the centroid to ensure pure rolling motion at the curved surface of at least three faces or shoes, where the rolling distance matches the lateral movement of the triangle’s top vertex.

In other embodiments, having additional faces or shoes is also possible. In fact, the rotating picking device 170 can be configured to have up to N faces in a N+1 system. Depending on the number of N faces of the rotating picking device 170, the number of indexing electrode singulation drums 150 and indexing separator singulation drums 160 may be adapted to ensure that each face or shoe of the rotating picking device 170 is utilized. Skilled persons will also appreciate that closed-form analytical techniques may be employed to develop arcuate gripper surface shapes. For example, the rotating picking device 170 can be configured to have four shoes orbiting in a five-sided space. Having an even number of shoes allows for dedicated shoes for anodes and cathodes, which minimizes material cross-contamination and increases the throughput of the rotating picking device 170.

In an embodiment, the rotating picking device 170 is configured to pick and release separator material and deposit the separator material between anodes and cathodes on the battery stack. The separator material may be transported together with the electrodes or transported separately. When the separator material is transported independently, the rotating picking device may be configured to pick a sheet of singulated separator material on alternating faces or shoes from electrodes from the face of an indexing electrode singulation drum 150 or indexing separator singulation drum 160 utilizing vacuum and air jets to hold and place the singulated sheet. In some embodiments, the rotating picking device 170 picks up multiple layers simultaneously, e.g., an electrode and a separator. There are two different picking strategies if the rotating picking device 170 is configured to pick up multiple layers. The first is the “conventional” pick, where the rotating picking device 170 is configured to pick a layer of separator first. Then, an electrode is placed on top of the separator material, and then both the separator material and the electrode are transferred to the battery stack 180 at the same time. This strategy relies on the porosity of the separator. If the porosity is too low, the electrode will not be picked up at high speeds.

The second picking strategy is the “inverted” pick; the inverted pick strategy uses a high flow, “leaky” end effector to pick the electrode first and the separator second. The high-flow end effector allows the separator to be picked and securely held due to the constant airflow around the edges of the electrode, which creates a suction force. Using the inverted pick method is porosity independent, thus allowing non-porous separators to be picked. This allows the stacking system 100 to handle a greater range of battery topologies, including prismatic, pouch-shaped, solid-state, or lithium foil-based.

In some embodiments, the stacking system 100 includes at least one rejection device for rejecting faulty or misaligned electrodes. The stacking system 100 may also include quality inspection devices, such as optical cameras, for determining if an electrode is faulty or misaligned. In an embodiment, the rejection devices are positioned near indexing electrode singulation drums 150 and indexing separator singulation drums 160. In some embodiments, the rejection devices are in the form of reject chutes, into which the electrodes are dropped.

Battery quality is a measurement of electrode placement accuracy. Quality inspection systems for battery stacking ensure that the electrodes (anodes and cathodes) and separators are properly aligned and defect-free before and during the stacking process. These systems often employ advanced technologies such as optical, X-ray, or laser-based sensors to detect misalignments, foreign particles, or material defects that could compromise battery performance and safety. Real-time monitoring is essential, as even minor deviations can lead to short circuits, reduced capacity, or thermal events. Inspection systems may also include impedance spectroscopy and other electrical testing methods to verify the integrity of the stacked layers.

Integrated with automation, these quality control systems enable continuous monitoring and corrective actions, minimizing defects and ensuring high reliability in the final battery stacks used in electric vehicles, energy storage, and other applications. In an embodiment, the quality inspection device includes an optical camera for determining if an electrode is faulty or misaligned. The control box 190 may be configured to receive real-time images of the edges of the battery material to detect misalignments and defects. If a misalignment or defect is detected, the control box 190 sends a signal to either the rejection device, the battery stacking station 185, or the battery stack removal system 700 to initiate a rejection process of the individual sheet of battery material or the entire stack.

In some embodiments, the quality inspection system is configured to generate a digital twin of the entire battery stack throughout the entire stacking process. Using a digital twin in quality inspection for battery stacking systems offers numerous benefits by creating a real-time, virtual replica of the physical manufacturing process. This advanced method allows manufacturers to simulate, monitor, and optimize production without interrupting the workflow. A digital twin can track and analyze data from various sensors in the battery stacking system, providing insights into potential defects, misalignments, or inconsistencies in the stacking of electrodes and separators. Manufacturers can make immediate adjustments by predicting issues before they occur, minimizing downtime, and reducing waste. Additionally, the digital twin enhances predictive maintenance by monitoring the health and performance of machinery, preventing breakdowns. Overall, this method improves the precision, efficiency, and reliability of the battery manufacturing process, ensuring higher quality control standards and reducing production costs.

For example, the stacking system 100 can compare the digital twin for various stacks, lots, or even individual battery material sheets as they move throughout the stacking system 100. By comparing the digital twin at multiple checkpoints throughout the stacking process, control box 190 can determine if there is an issue with a specific subsystem. Additionally, by comparing the digital twin between various lots of batteries, the control box 190 can automate the detection, classification, and reporting of potential recalls due to misalignments or defects.

In an embodiment, the quality inspection system is enhanced by using cameras in conjunction with strategically placed mirrors 260 to enable real-time optical inspection of the battery stack. This configuration works by bouncing the optical image off the rotating picking device 170, allowing the system to capture a clear view of the top layer of the battery stack 180 on the stacking platform 185. This method provides a non-invasive and highly accurate way to inspect the alignment, positioning, and condition of the anodes, cathodes, and separators as they are stacked. By using mirrors to reflect the image, the system can inspect layers without interrupting the stacking process, ensuring continuous monitoring. This setup also helps detect defects or misalignments in real time, allowing for immediate corrective action, which enhances overall product quality and reduces waste. The camera and mirror system provides an efficient and cost-effective means of ensuring precision in high-speed battery stacking operations.

In some embodiments, the system further comprises electrode cleaning stations upstream of the respective indexing electrode singulation drums 150 and indexing separator singulation drums 160. The cleaning stations are adapted to clean and optionally deburr the battery material prior to transporting them to the rotating picking device 170.

Such electrode cleaning stations may comprise two air bearings opposite to and close to each other, such that electrodes are transported through the two air bearings to clean and deburr them using the air pressure. In an embodiment, the distance between two such air bearings is the same as the distance between the electrodes, which may be less than two microns. In embodiments, the distance between two such air bearings may be larger than the distance between the electrodes. Other spacings will be readily appreciated by a person of skill in the art and may be selected based on other parameters of the system.

The cleaning stations may, in some embodiments, include other ways of cleaning the electrodes, such as ultrasonic cleaning, solvent baths, or electro-cleaning. The cleaning stations may also comprise other means of deburring the electrodes, such as mechanical brushing, abrasive blasting, or chemical deburring.

A control box 190 (not shown) is coupled to the stacking device 100. The control box 190 includes various control components or processors, such as PLCs, sensors, displays, etc., that adjust multiple parameters, receive sensor data, and control the stacking device 100. The control box 190 is configured to control various functions of the stacking device 100, including but not limited to rejection, quality inspection, battery material alignment, pick and place operations, and vibrational analysis. A person of skill in the art would understand that the discrete tasks disclosed throughout may be performed within a single control box 190 or multiple control box 190s, depending on the needs of the upstream and downstream processes.

Vibrational analysis plays a critical role in monitoring and optimizing battery stacking machines by detecting mechanical irregularities or misalignments in real time. During the stacking process, this technique measures the vibration patterns of moving components, such as the rotating picking device 170, indexing electrode singulation drums 150, and indexing separator singulation drums 160. Any deviation from normal vibration signatures can indicate issues like wear, imbalance, or misalignment in the machinery, which could negatively affect the precision of stacking anodes, cathodes, and separators.

By identifying these anomalies early, operators can prevent potential defects in battery stacks, such as misaligned electrodes, which may lead to performance degradation or safety risks. Additionally, vibrational analysis can help optimize machine performance, ensuring smoother operation, longer machine life, and reduced downtime for maintenance, contributing to overall efficiency and cost-effectiveness in battery manufacturing. In an embodiment, the control box 190 performs vibrational analysis on the stacking system 100 to ensure proper alignment and operation during stacking.

In an embodiment, the control box 190 is configured to monitor the temperature throughout the stacking system 100. Temperature-related issues in cathodes, anodes, and separator materials can significantly affect the performance, safety, and longevity of batteries. Excessive heat can cause degradation in cathode and anode materials, leading to a loss in electrochemical performance, reduced capacity, and shorter battery life. Elevated temperatures can also damage the delicate separator material, which serves as a barrier between the anode and cathode to prevent short circuits. If the separator material shrinks, melts, or develops holes due to heat, it can result in internal short circuits, increasing the risk of thermal runaway and potential battery fires. Additionally, fluctuations in temperature can cause uneven thermal expansion, leading to misalignment of the electrodes and separators, further degrading battery performance. Effective thermal management is, therefore, crucial in battery stacking and assembly processes to ensure the integrity and safety of the final product.

The control box 190 may also be configured to activate or deactivate various upstream or downstream apparatuses, such as indexing electrode singulation drums 150 and indexing separator singulation drums 160 or any component within the various in-feed regions.

In an embodiment, the control box 190 includes a display (not shown) configured to display a human-machine interface (“HMI”) containing information on the stacking system 100. A user may interact with the HMI and display to set various parameters of the stacking system 100.

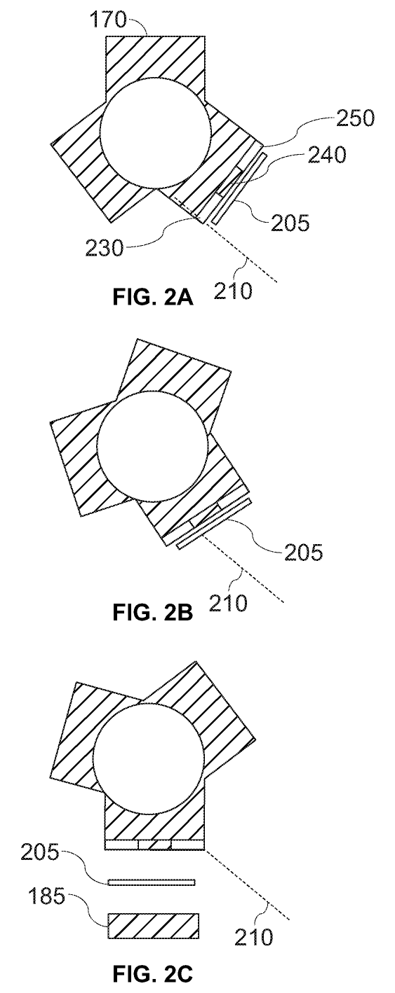

As shown in FIG. 2, when transferring battery material from, e.g., the picking device 170 to the battery stacking station 185, the battery material is released in several steps, i.e., gradually rather than all at once. By releasing battery material one part at a time, a smoother and more accurate transfer may be achieved, decreasing the risk of damaging the battery material. In the embodiment described below, the gradual transfer of battery material is performed by the rotating picking device 170, where each face or show of the rotating picking device 170 includes multiple vacuum zones, e.g., 230, 240, and 250, for adhering and propelling battery material to/from the surface of the rotating picking device 170.

To achieve a gradual transfer, the surface of the faces or shoes of the rotating picking device 170 contains multiple zones 230, 240, and 250 in which a vacuum or jet of air may be applied individually. The angular position of each vacuum zone is tracked to determine if the various vacuum zones 230, 240, and 250 have reached a predetermined position.

In order to keep track of individual zones 230, 240, and 250, standalone devices may be used. Such devices may be standalone processing devices comprising processing circuitry, such as a microcontroller or digital signal processor, which may include one or more programmable processors, application-specific integrated circuits, field programmable gate arrays, or combinations.

One example of such a device is an output compare device, adapted to compare a value against another value and optionally perform an action when a specific value is detected or exceeded.

When the predetermined position is reached, the multiple vacuum zones 230, 240, and 250 are turned off. When this predetermined position is reached for the specific zone, the standalone device signals that the vacuum is to be turned off. The same applies to the standalone device of the next zone, the next, and so on.

In some embodiments, the standalone device is adapted to transmit its position to another processing or computing device. Such a computing device may be associated with the picking device 170, which keeps track of the rotating picking device 170’s position. The computing device of the rotating picking device 170 may be adapted to turn on and off the vacuum zones. Data between processing devices and/or computing devices may be transmitted wirelessly. Using electronics to track and actuate the multiple vacuum zones 230, 240, and 250 may lead to higher maintenance costs due to the high cycles experienced by the high-speed stacking system 100.

In an alternative embodiment, instead of relying on electronic control systems to manage the multiple vacuum zones 230, 240, and 250, the design incorporates a series of internal baffles, plumbing, and mechanical valves. These components enable the rotating picking device 170 to mechanically switch the vacuum and air jets on and off without the need for complex electronics. As the rotating device moves through its cycle, the internal baffles direct airflow to specific zones, automatically activating or deactivating the vacuum and air jets in sync with the machine’s motion. This mechanical approach simplifies the system, reducing reliance on electronic components, which can be prone to failure or require significant maintenance. It also offers a more robust and potentially cost-effective solution, especially in environments where durability and reliability are critical. This system can streamline the manufacturing process by minimizing the need for electronic controls while maintaining precise control over the gripping and release of materials during battery stacking operations. By eliminating electronics, such as relays, the rotating picking device 170 is able to reduce downtime and maintenance costs.

This is illustrated in FIGS. 2A-2C. In FIG. 2A, the picking device adheres battery material 205 to its surface using a vacuum. The face of the picking device holding the battery material 205 comprises a first vacuum zone 230, a second vacuum zone 240, and a third vacuum zone 250. The same applies to FIGS. 2B and 2C, but references are omitted.

As the rotating picking device 170 rotates from the position in FIG. 2A towards the release position in FIG. 2C, it passes the predetermined level 210 for when the vacuum is to be turned off. Since each zone 230, 240, and 250 is associated with its processing device or set of internal plumbing, the respective processing device keeps track of its position relative to the predetermined position 210. It turns off the vacuum when that position is reached.

In FIG. 2B, the first vacuum zone, 230, has been turned off, and the second vacuum zone, 240, is about to be turned off. When the picking device 170 reaches the position of FIG. 2C, the third zone 250 is also released, which results in electrode 205 being released from the rotating picking device 170 towards battery stacking station 185. In some embodiments, it may be released with virtually no distance to the battery stack, and in some embodiments, it may be released and fall some distance before it reaches the battery stack.

In some embodiments, the rotating picking device 170 may be adapted to use air to push battery material 205 away from the rotating picking device 170 as it is being released. This may entail that when the respective zones 230, 240, and 250 pass the predetermined position 210, the vacuum is turned off, and an air jet is turned on.

Throughout this document, multiple devices use suction to adhere electrodes and/or separator material to them. Such suction may be achieved using differential pressure, which a vacuum may achieve.

In some embodiments, the suction may be replaced by other means of adhering a material to a surface. Such means may be, e.g., mechanical clamping, electrostatic, tacky or sticky surfaces, and similar solutions.

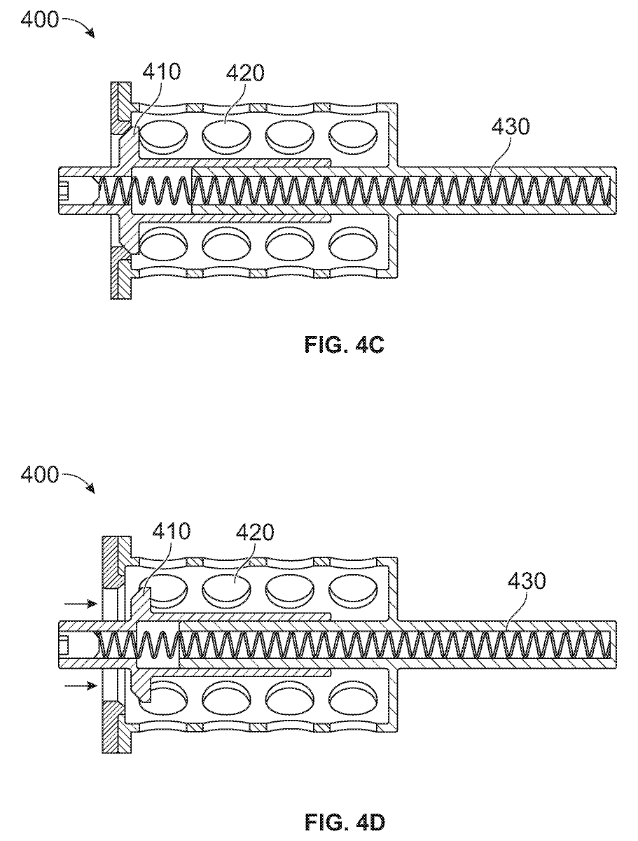

Looking now at FIG. 4A, an embodiment of indexing electrode singulation drums 150 and indexing separator singulation drums 160 is shown as a rotating body 300.

Although the faces 310 may be identical and change positions as the rotating body 300 of the drum rotates, they will, for the purpose of FIGS. 4A-4D, be referenced collectively as faces 310.

At least one of the positions of the faces of the singulation device 300 is a cutting position in which the battery material is cut. At least one of the positions is a receiving position where the rotating body 300 receives the battery material from an accumulation or steering device. In some embodiments, at least one position is an output position adapted to hand off the battery material to a downstream picking device after it has been cut. In some embodiments, these positions may overlap, especially in embodiments wherein the singulation device comprises a few faces, such as two. For example, the first position may be both a receiving position and a cutting position, and/or the second position may be both a cutting position and an output position.

The faces 310 are configured to receive battery material fed from an accumulation or steering device. The faces 310 are further configured to include a series of holes or perforations that generate a vacuum and air jet force. The faces use the vacuum force to secure the battery material to the faces 310.

In some embodiments, each face is adapted to adhere to the battery material by suction. The suction may be provided by a vacuum source connected to the rotating body 300. In some embodiments, the faces 310 may be adapted to adhere to the battery material by other means, such as electrostatically, mechanically, or sticky or tacky surfaces.

In some embodiments, the rotating body 300 is adapted so that each face 310 may be controlled individually with respect to adhering the battery material to the respective face. In some embodiments where the adhering is achieved by suction, the amount of suction provided can be adjusted for each face 310 individually. In some embodiments, the rotating body 300 is adapted such that the adhering of battery material is either on or off for all faces simultaneously. In embodiments wherein the adhering is accomplished via suction, it may entail that all faces are provided with the same amount of suction.

The rotating body 300 rotates around a central axis. The rotating body 300 rotates symmetrically around the axis, but in some embodiments, the rotating body 300 may also rotate asymmetrically.

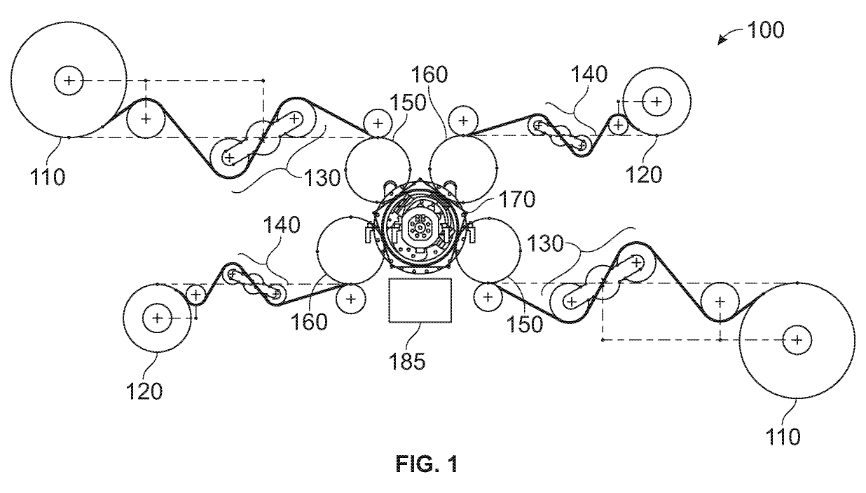

In some embodiments, the rotating body 300 rotates using an indexing motion, such that it first accelerates relatively quickly from a standstill and then decelerates relatively quickly in order to position the battery material for cutting and/or for being picked up by a picking device. A complete stop typically follows the deceleration, but in some embodiments, it may comprise a slow rotation speed without ever stopping completely. In the embodiment of FIG. 1, one rotation operation or one index motion would rotate the body 36 degrees, such that a position of the first face 310 advances 1/10 of a full rotation.

The rotating body 300 further comprises a cutting device 360 (not shown). In some embodiments, the cutting device 360 may be incorporated into the same structure as the rotating body 300. In some embodiments, such as the one shown in FIG. 1, the cutting device is external to the rotating body 300 and configured to cut battery material using lasers. The cutting device 360 may also be configured to monitor and cut the misaligned battery material on the rotating body 300. While system 100 includes a steering device, the web of battery material may still end up misaligned with the rotating body 300. When this happens, the cutting device 360 will trim the web of battery material to remove the excess battery material hanging off the rotating body 300.

The cutting device 360 comprises a cutting edge 365 adapted to cut the battery material while it is being adhered to the face of the rotating body 300. In some embodiments, the cutting edge 365 may be a physical cutting edge such as a knife or a sharp edge. In some embodiments, the cutting edge 365 may be a laser or another type of energy source. In some embodiments, the cutting edge 365 may comprise a hot knife or a hot wire.

In some embodiments, each face 310 may comprise an internal cutting device, which cuts the battery material from the inside with respect to the rotating body 300. By having an internal cutting device on each face, it is easier to cut the battery material during the motion of the singulation device 100, which may be beneficial in some implementations.

In some embodiments, each face 310 of the rotating body 300 includes a feature adapted to receive the cutting edge 365 of the cutting device 360.

The rotating body 300 receives the web of battery material as the rotating body 300 indexes. When the battery material is being pulled onto the rotating body 300, the battery material adheres to the faces 310 on the rotating body 300 due to a suction force. The rotating body 300 is then rotated such that the battery material indexes one depositing position and new battery material is withdrawn from the steering or accumulation device. When the battery material is advanced more than one indexing motion, it is cut by the cutting edge 365 of the cutting device 360.

The rotating body 300 then rotates again, transferring the battery material from face 310 to the rotating picking device 170. Since the battery material was cut, it is no longer part of a web or continuous sheet of material and can be transferred.

In some embodiments, transferring the battery material from either of the faces 310 requires releasing the adhering of the battery material to the face. If it is adhered to by suction, this would comprise releasing or lessening the suction.

In some embodiments where the battery material is transferred, suction may be released, and the battery material would fall onto the rotating picking device 170.

In some embodiments, the rotating body 300 may further comprise a mechanism for rejecting faulty or damaged pieces of battery material, after it has been cut. Rejection is handled using air to push the battery material away from the face 310 after it has been cut. Typically, such a rejection is performed after face 310 has rotated past the depositing position. The air used to push the battery material away may also be generated using the same source that applies suction to the faces of the body 300; for example, the suction may be reversed into positive pressure to blow off the sheet of battery material.

In some embodiments, each face 310 of the rotating body 300 can be deflected individually in order to allow for a picking device to pick the battery material without colliding or risking interfering with the rotating body 300. In some embodiments, such deflection may be accomplished by spring means associated with each face 310.

The rotating body 300 can be configured to gradually, rather than all at once, transfer the singulated battery material. By releasing the singulated battery material one part at a time, a smoother and more accurate transfer may be achieved, decreasing the risk of damaging the battery material.

To achieve a gradual transfer, the surface of the faces of the body may contain multiple zones in which a vacuum or jet of air may be applied individually. The angular position of each vacuum zone is tracked to determine if the various vacuum zones have reached a predetermined position. The multiple vacuum zones are turned off when the predetermined position is reached.

The battery material may be fed from any source that is able to output the battery material to the rotating body 300 without breaking or damaging the battery material. Due to the index motions used comprising rapid acceleration, it may be necessary to withdraw the battery material from a source with low or no inertia and/or friction. In some embodiments, the battery material is withdrawn from an accumulation device adapted to output the battery material specifically to the rotating body 300.

In some embodiments, the rotating body 300 may further comprise an alignment bar, which ensures that the battery material is fed onto the rotating body 300 optimally.

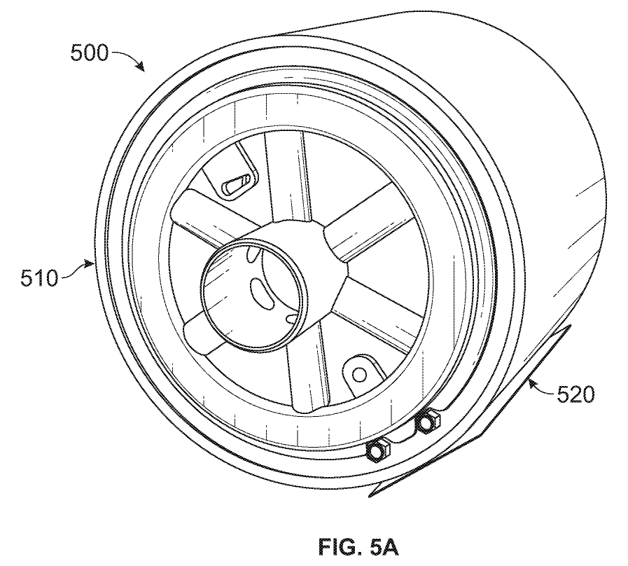

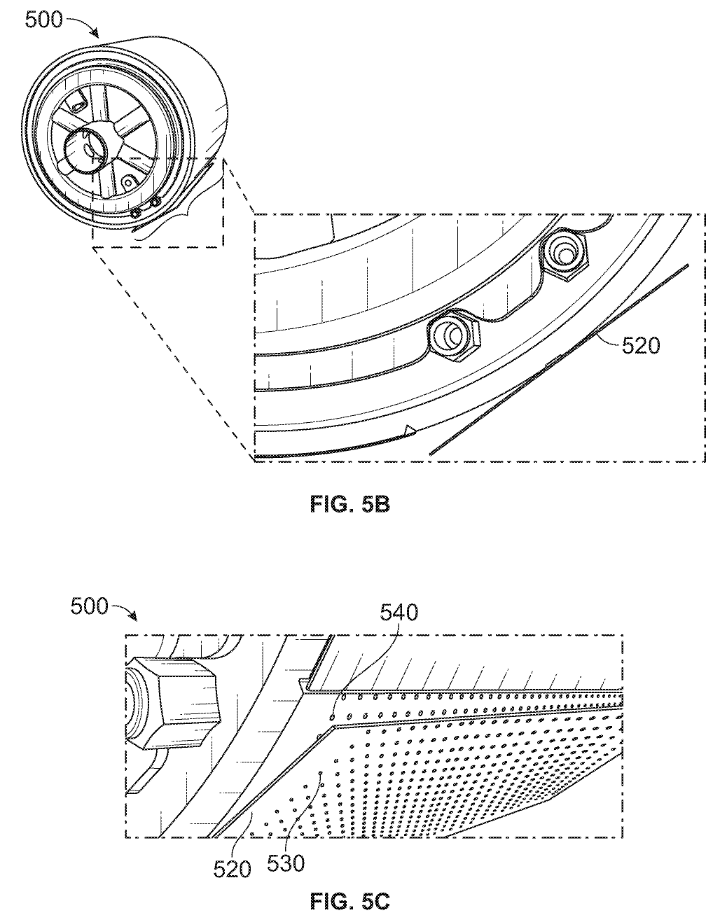

In the embodiment illustrated in FIGS. 4A-4D, the rotating body 300 comprises six faces 310. In another embodiment, illustrated in FIGS. 5A-5C, the rotating body 300 comprises ten faces that are deformable. As with each of the various embodiments, the adhering of battery material to a single face may be accomplished individually or collectively for all faces, depending on the implementation.

In some embodiments, each face of the rotating body 300 can deflect inwardly using one or multiple springs.

In some embodiments, each face of the rotating body 300 comprises a feature 310 adapted to receive a laser beam or similar, in case the cutting edge comprises a laser. The feature 310 may deflect the laser beam so that it doesn’t risk damaging the body 300.

In some embodiments, including both the ones shown in FIG. 1 and FIGS. 4A-4D, the surface material of the face of the body of the singulation device, i.e., the surface on which the battery material is positioned and adhered, is made of any type of plastic material, aluminum, or titanium. In some embodiments, the material may be glass-impregnated nylon.

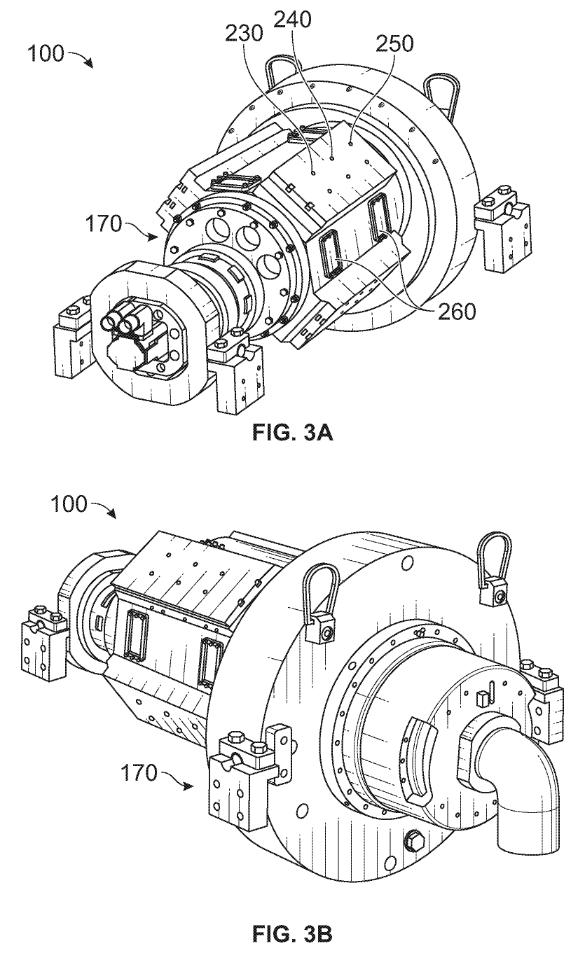

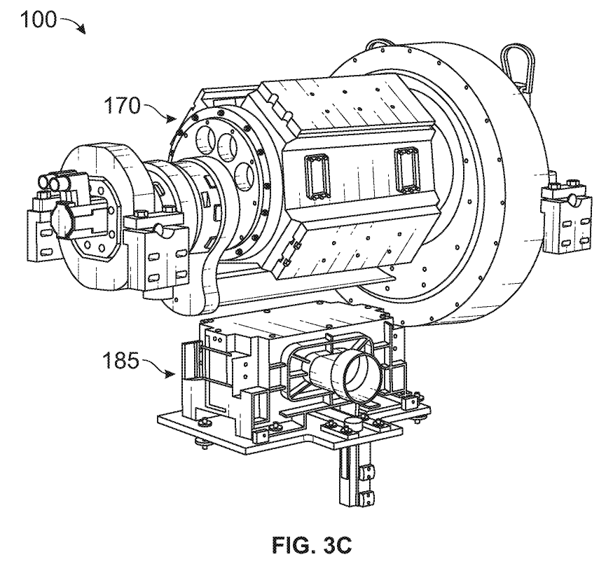

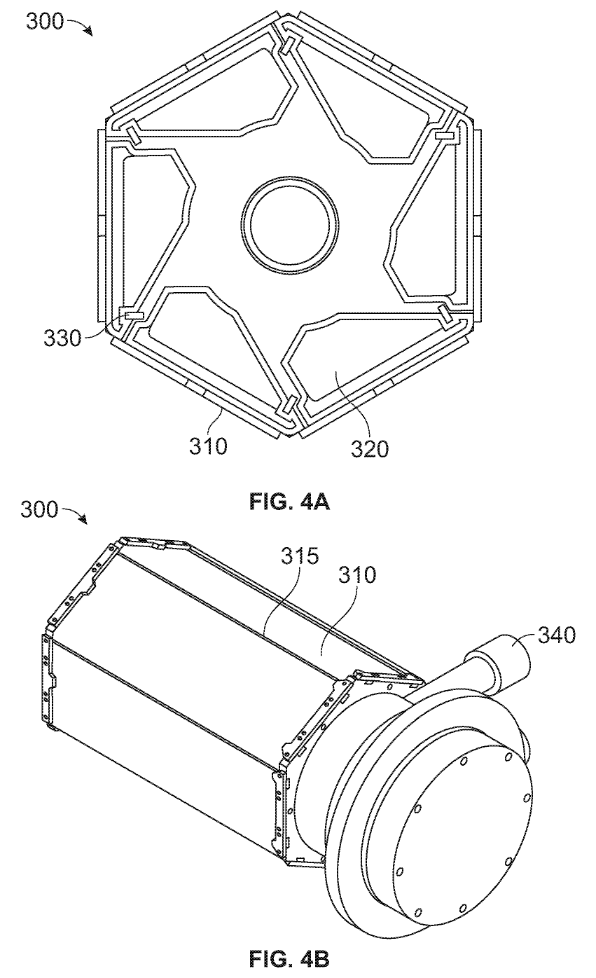

FIG. 4B shows another view of a six-sided singulation device 300, showing the faces 310 as well as a recess 315 in between each face through which the cutting edge of the cutting device may be employed in order to cut the battery material. FIG. 3B further shows a vacuum supply 340 for providing suction to the faces 310.

Looking now at FIGS. 4C and 4D, a mechanism for regulating the suction of the faces of the body used to adhere to the battery material, will now be described. FIG. 4C shows a closed position where no air is let in, and FIG. 4D shows an open position in which air is let in.

The mechanism may be used regardless of the number of faces of the body, and it may be used either for all faces simultaneously or for each face individually. In an embodiment, the mechanism is positioned inside the singulation device body 300. As will be understood, the body 300 may comprise one or a plurality of vacuum regulation mechanisms 400.

The mechanism 400 comprises a valve 410, which may be opened and closed in order to adjust the amount of air or other gas that is let in, which in turn regulates the amount of vacuum. The valve 410 may be continuously positionable between an opened and a closed position, such that the amount of air that is let in can be continuously adjusted and not have only two discrete positions.

The mechanism further comprises a number of holes 420, adapted to let air or gas through in order to apply the suction to the faces of the singulation device. The holes 420 are generally positioned on the surface of the faces of the singulation device.

The mechanism may further comprise a spring 430, which may automatically or semi-automatically adjust the amount of air that is let in, thereby regulating the vacuum. When the amount of vacuum inside the mechanism increases, the spring 430 is contracted, which decreases the extension of the spring and opens valve 410, which in turn lets more air into the mechanism. When more air is let in, the amount of vacuum decreases, which decreases the pressure on the spring and lets the spring extend, which closes valve 410 and increases the amount of vacuum in the mechanism.

By having an automatically adjustable mechanism for regulating the vacuum, a more robust and efficient application of suction on the faces of the singulation device may be achieved.

FIGS. 5A-5C show the indexing electrode singulation drums 150 and indexing separator singulation drums 160, according to one embodiment. In an embodiment, the rotating singulation drum 500 has ten deformable faces 520. The deformable faces 520 can be any material with a sufficient spring coefficient such that the deformable face 520 will return to a substantially flat orientation, as illustrated by one of the deformable faces 520 in FIGS. 5A-5C. The arc angle of the deformable faces 520 can be adapted to the battery material properties. For example, if the battery material is more flexible, the radius can be smaller and provide the deformable face 520 with a greater curve. However, if the battery material is stiffer, the radius can be increased such that the deformable face 520 matches the battery material’s properties and allows for the battery material to be singulated and transported to the rotating picking device 170.

The deformable faces 520 are deformed utilizing a suction force generated by rotating singulation drum 500. The rotating singulation drum 500 controls the suction or jet of air outputted through holes 540 to flex or deform the deformable faces 520 between a curved and flat orientation. When in the curved orientation, the deformable faces 520 create a substantially circular profile that allows the continuous web of battery material to roll around the surface of the rotating singulation drum 500. When the deformable faces 520 are in the flat orientation, the deformable faces 520 deposit a singulated sheet of battery material to the rotating picking device 170.

The deformable faces 520 are configured with holes 530 that allow the suction or jet of air produced by the rotating singulation drum 500 to pass through. This provides the suction force or jet of air needed to adhere singulated battery material to the deformable faces 520. As stated above, the faces 520 can have multiple vacuum zones and gradually transfer the singulated battery material to the rotating picking device 170.

In an embodiment, the rotating singulation drum 500 can be steered along the axis of rotating in the cross-feed direction to make adjustments to the web of battery material to prevent misalignments.

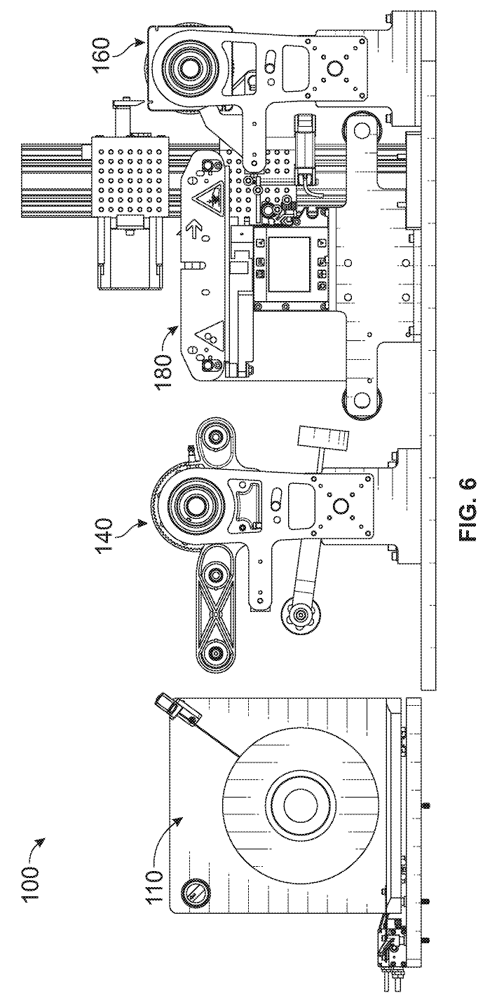

FIG. 6 shows an exemplary infeed region in which a rotating singulation drum 500 may be used, according to an aspect of the present disclosure. The infeed region requires some type of device to feed the battery material to it. Due to the index motion used by the rotating singulation drum 500 to withdraw the battery material, comprising a rapid acceleration followed by a rapid deceleration and typically a complete stop, the battery material must be fed in a virtually frictionless way, which in turn entails that the withdrawal of battery material is virtually free from inertia. If this is not the case, the withdrawal of the battery material with such an index motion would damage the battery material, or it would not be possible at all.

In some embodiments, the rotating singulation drum 500 may be fed by a dynamic accumulation device 140, which in turn is receiving battery material from a dispensing device 110. The dispensing device 110 may be a dereeler assembly comprising a roll of battery material wound around an air chuck.

Withdrawing the battery material with an index motion as described herein would not be possible from such a dispensing device 110. Thus, an intermediary device in the form of a dynamic accumulation device 140 is required.

The dynamic accumulation device 140 is adapted to receive battery material from the dispensing device 110 at a constant speed and output the battery material at a variable speed to the rotating singulation drum 500, wherein the variable speed may be the index motion with which the rotating singulation drum 500 withdraws the battery material from the dynamic accumulation device 140.

In some embodiments, the dynamic accumulation device 140 may comprise a dancer’s arm and a treadle, wherein the battery material is adapted to travel with the constant speed through the rollers of the dancer’s arm and treadle to travel with the variable speed through the rotating singulation drum 500.

In some embodiments, the system may further include an alignment device 190 that adjusts the battery material in real time using the quality inspection device to make small adjustments in the cross-feed direction to ensure that the battery material is fed onto the rotating body 160 or rotating singulation drum 500 with the proper alignment.

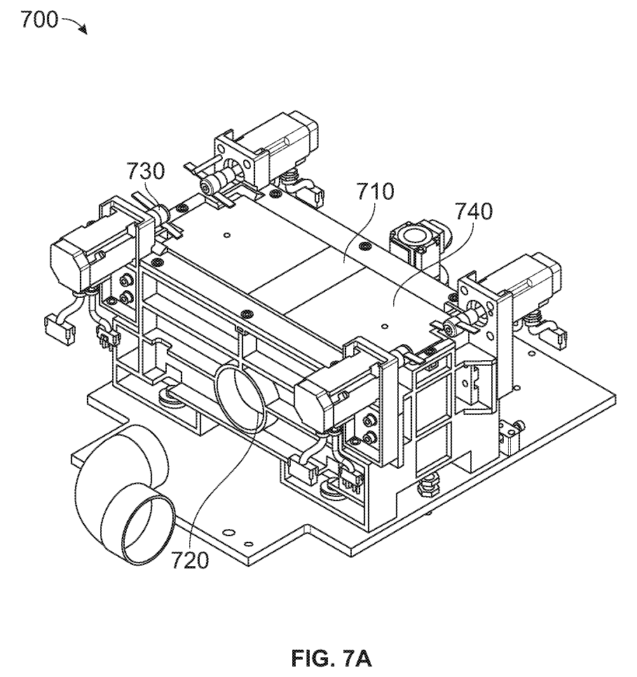

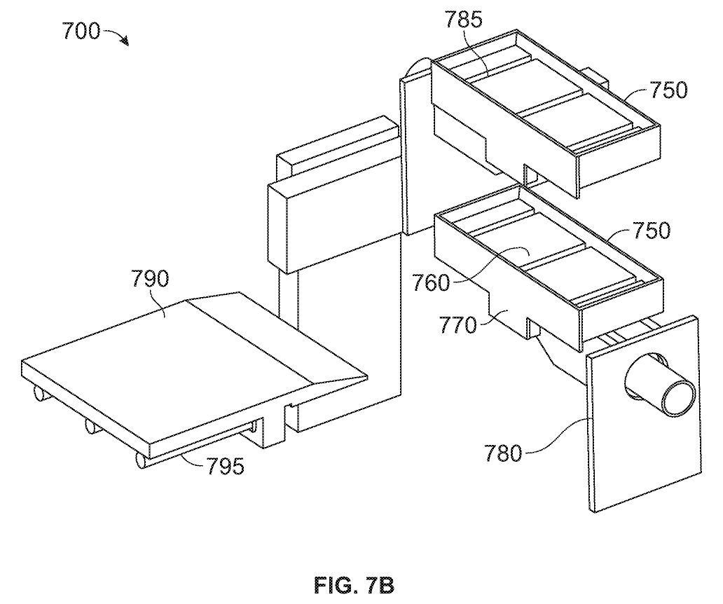

FIGS. 7A and 7B show a battery stacking station 700 according to an embodiment. The battery stacking station 700 may be the battery stacking station 185 of FIG. 1 or FIG. 2C. As illustrated, the battery stacking station 700 comprises a platform 710, onto which a battery stack will be positioned. The battery stack typically comprises alternating layers of anodes and cathodes, with separator material in between. The separator material may be in the form of a continuous sheet that is folded between the electrodes or in the form of separate sheets.

The battery stacking station 700 further comprises four walls surrounding the platform and a hollow interior. In some embodiments, the platform 710 is adapted to lower as layers of battery material are placed on it. The layers of battery material may be positioned on platform 710 by a rotating picking device 170. In some embodiments, station 700 may comprise an elevator mechanism that can lower and raise platform 710. The elevator mechanism may, in some embodiments, include a screw positioned inside station 700, below platform 710, such as a jackscrew.

The battery stacking station 700 further comprises a vacuum port 720 for connection to a vacuum source. When the vacuum source is connected to the vacuum port 720, a vacuum is created inside the battery stacking station, which adheres the battery material to platform 710. Along the surrounding edge of platform 710 is a small gap 740 that generates a suction force using the vacuum source attached to vacuum port 720. The suction force generated using gap 740 creates a downward force on the surrounding edge of platform 710. As battery material is stacked on top of platform 710, the downward force generated is applied to the edges of each battery material sheet, holding it into place.

By using a vacuum to suction and adhere the battery material to platform 710, a more robust system that is less prone to misalignment and other position errors may be achieved without using mechanical solutions that may be prone to damage the battery stack. It may also help stabilize the battery stack and simplify the positioning of new battery material.

In some embodiments, station 700 may further comprise flexible clamping, meaning 730 is intended to contact the top layer of the battery stack to further fixate the battery stack on platform 710. The flexible clamping means may comprise two flaps on a rotating body, with the two flaps extending in opposite directions. The body is adapted to rotate 180 degrees when the next layer of battery material is placed on the stack, such that the flap holding down the battery stack is removed when the top layer is placed. The other flap rotates to be on top of the newly placed layer.

FIG. 7B shows a system 400 for battery stack removal, comprising two battery stacking stations 750 of a different embodiment than shown in FIG. 3, and shows method steps for battery stack removal using two such battery stacking stations 750. Not all features are referenced on battery stacking station 750, but they typically comprise the same features. In some embodiments, the battery stacking stations 750 are identical.

As further illustrated, the battery stacking stations 750 each comprise a floor 760 onto which a battery stack is placed. It further includes a front wall 770, which can be lowered. The station 750 may further comprise a hollow interior and/or be connected to a vacuum source, which creates a suction that adheres the battery stack to floor 760. In some embodiments, floor 760 is stationary and cannot be lowered or raised, as are the other three walls apart from the front wall 770.

The system further comprises a stack removal device 790, comprising prongs 795 adapted to extend from the device 790, adapted to be positioned below a formed battery stack.

The battery stacking stations 750 may, in some embodiments, comprise recesses or channels 785 in the floor adapted to receive the prongs 795, positioned below the floor 760 and thus enable the prongs 795 to be positioned below the floor 760 where the bottom layer of a battery stack is positioned.

Station 750 may be positioned on arms or other mechanical transportation devices adapted to transport the battery stacking station 750 along at least two axes. In some embodiments, station 750 may be moved freely in space by transportation devices. The battery stacking station 750 may be moved up, down, and laterally in two opposite directions in order to position it in the system. The stations have at least four positions: a top right, bottom right, top left, and lower left position. In some embodiments, the battery station 750 may be freely and continuously positionable between these positions. In some embodiments, the top right position is where the battery stack is positioned onto station 750, and the bottom right position is where the removal device 790 removes a completed battery stack from station 750.

The battery stacking station 750 is also configured to move along an axis perpendicular to the removal device 790 to correct misalignments between layers as they are being stacked using the cameras disclosed above. The movements of the battery stacking station 750 are based on the quality inspection system stated above, which includes cameras and mirrors affixed on the rotating picking device 170. By adjusting the positions as each layer of battery material is deposited onto the battery stacking station 750 from the rotating picking device 170, the battery stacking station 750 can correct misalignments between layers. This improves the battery stack quality, which leads to higher capacity and less waste material.

The previous examples have been provided merely for explanation and are in no way to be construed as limiting the present invention disclosed herein. While the invention has been described regarding various embodiments, it is understood that the words used herein are words of description and illustration rather than words of limitation. Further, although the invention has been described herein concerning particular means, materials, and embodiments, the invention is not intended to be limited to the particulars disclosed herein; instead, the invention extends to all functionally equivalent structures, methods, and uses, such as are within the scope of the appended claims. Those skilled in the art, having the benefit of the teachings of this specification, may effect numerous modifications thereto, and changes may be made without departing from the scope and spirit of the invention in its aspects.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other construction details are believed to be well within the ability of one of even rudimental skills in this area, in view of the present disclosure. Illustrative embodiments of the present invention have been described in considerable detail for the purpose of disclosing a practical, operative structure whereby the invention may be practiced advantageously.

The designs described herein are intended to be exemplary only. The novel characteristics of the invention may be incorporated into other structural forms without departing from the spirit and scope of the invention. The invention encompasses embodiments both comprising and consisting of the elements described with reference to the illustrative embodiments. Unless otherwise indicated, all ordinary words and terms used herein shall take their customary meaning. All technical terms shall take on their customary meaning as established by the appropriate technical discipline utilized by those normally skilled in that particular art area.

1. An apparatus for continuously stacking singulated battery, comprising:
a rotating singulation drum, the rotating singulating drum includes a vacuum-assisted gripping face;
a gripping shoe coupled to the singulation drum;
wherein the rotating singulation drum is configured to singulate and transfer a sheet to a rotating picking prism; and
wherein the rotating picking prism is further configured to capture the sheet from the vacuum-assisted gripping face of the rotating singulation drum using the gripping shoe coupled to the rotating picking prism.

2. The apparatus of claim 1, wherein the sheet comprises at least one of an anode sheet, a cathode sheet and a separator sheet.

3. The apparatus of claim 1, further comprising an infeed region that includes an electrode dispensing device, an electrode accumulation and steering device, and an indexing electrode singulation drum, wherein the infeed region is equipped with a sensor to ensure a singulated battery material is correctly positioned and aligned before entering a battery stacking system.

4. The apparatus of claim 2, wherein the rotating singulation drum is a first rotating singulation drum, wherein the first rotating singulation drum is configured to singulate and transfer an anode sheet from a first upstream process.

5. The apparatus of claim 2, wherein the rotating singulation drum is a second rotating singulation drum, wherein the second rotating singulation drum is configured to singulate and transfer a cathode sheet from a second upstream process.

6. The apparatus of claim 2, wherein the rotating singulation drum is a third rotating singulation drum, wherein the third rotating singulation drum is configured to singulate and transfer a separator sheet from a third upstream process.

7. The apparatus of claim 2, wherein the rotating singulation drum is a fourth rotating singulation drum, wherein the fourth rotating singulation drum is configured to singulate and transfer a separator sheet from a fourth upstream process.

8. The apparatus of claim 1, wherein the rotating singulation drum includes an alignment device, the alignment device configured to align an electrode and a separator.

9. The apparatus of claim 1, further comprising a quality inspection device, the quality inspection device adapted to continuously monitor a cathode, a separator, and an anode and take corrective action before transfering to the rotating singulation drum or rotating picking prism.

10. The apparatus of claim 1, wherein the capture by the rotating picking prism is an inverted pick of the sheet.

11. A method for continuously stacking singulated battery material, comprising the steps of:
coupling a vacuum-assisted gripping shoe to a rotating singulation drum;
configuring the rotating singulation drum to singulate and transfer a sheet from an upstream process to a rotating picking prism; and
capturing the sheet from the vacuum-assisted gripping face of the rotating singulation drum using the gripping shoe coupled to the rotating picking prism.

12. The method of claim 11, wherein the sheet comprises at least one of an anode sheet, a cathode sheet and a separator sheet.

13. The method of claim 11, further comprising an infeed region that includes an electrode dispensing device, an electrode accumulation and steering device, and an indexing electrode singulation drum, wherein the infeed region is equipped with a sensor to ensure a singulated battery material is correctly positioned and aligned before entering a battery stacking system.

14. The method of claim 12, wherein the rotating singulation drum is a first rotating singulation drum, wherein the first rotating singulation drum is configured to singulate and transfer an anode sheet from a first upstream process.

15. The method of claim 12, wherein the rotating singulation drum is a second rotating singulation drum, wherein the second rotating singulation drum is configured to singulate and transfer a cathode sheet from a second upstream process.

16. The method of claim 12, wherein the rotating singulation drum is a third rotating singulation drum, wherein the third rotating singulation drum is configured to singulate and transfer a separator sheet from a third upstream process.

17. The method of claim 12, wherein the rotating singulation drum is a fourth rotating singulation drum, wherein the fourth rotating singulation drum is configured to singulate and transfer a separator sheet from a fourth upstream process.

18. The method of claim 12, wherein the rotating singulation drum includes an alignment device, the alignment device configured to align an electrode and a separator.

19. The method of claim 12, further comprising a quality inspection device, the quality inspection device adapted to continuously monitor a cathode, a separator, and an anode and take corrective action before transfering to the rotating singulation drum or rotating picking prism.

20. A system for continuously stacking singulated battery material, the system comprising:
a first rotating singulation drum, wherein the first rotating singulation drum is configured to singulate and transfer anode sheets from a first upstream process;
a second rotating singulation drum, wherein the second rotating singulation drum is configured to singulate and transfer cathode sheets from a second upstream process;
a third rotating singulation drum, wherein the third rotating singulation drum is configured to singulate and transfer separator sheets from a third upstream process;
a fourth rotating singulation drum, wherein the fourth rotating singulation drum is configured to singulate and transfer separator sheets from a fourth upstream process;
wherein the first, second, third, and fourth rotating singulation drum includes at least one deformable vacuum-assisted face, wherein the rotating singulation drum is configured to transfer an anode, a cathode, and a separator from the respective rotating singulation drums to a rotating picking prism using the at least one deformable vacuum-assisted gripping face;
wherein the rotating picking prism is further configured to pick the anode, the cathode, and the separator from the at least one vacuum-assisted gripping face of the rotating singulation drum using one of at least three gripping shoes coupled to the rotating picking prism.
